(19) United States
(12) Patent Application Publication
(10) Pub. No.: US 2015/0378336 A1
(43) Pub. Date: Dec. 31, 2015

(54) ELECTRICAL APPLIANCE AND METHOD FOR CONTROLLING THE OPERATION OF AN ELECTRICAL APPLIANCE

(71) Applicant: DIEHL AKO STIFTUNG & CO. KG, WANGEN (DE)

(72) Inventor: MATHIAS GLASMACHER, REILINGEN (DE)

(21) Appl. No.: 14/844,222

(22) Filed: Sep. 3, 2015

Related U.S. Application Data
(63) Continuation of application No. PCT/EP2014/000414, filed on Feb. 14, 2014.

(30) Foreign Application Priority Data
Mar. 6, 2013 (DE) 102013003852.9

(51) Int. Cl. G05B 19/042

(52) U.S. Cl. CPC G05B 19/0426; G05B 2219/23328

(57) ABSTRACT

An electrical appliance has at least one assembly, an operating apparatus for selecting a program sequence from at least one predefined program sequence by a user of the electrical appliance, and a control apparatus for actuating the at least one assembly in accordance with a selected program sequence. A communications interface via which the control apparatus can communicate with an intelligent energy supply grid, is provided. The control apparatus is configured to modify the selected program sequence depending on energy supply information obtained from the intelligent energy supply grid during execution of the selected program sequence within predetermined limits and to actuate the assembly in accordance with a modified program sequence.

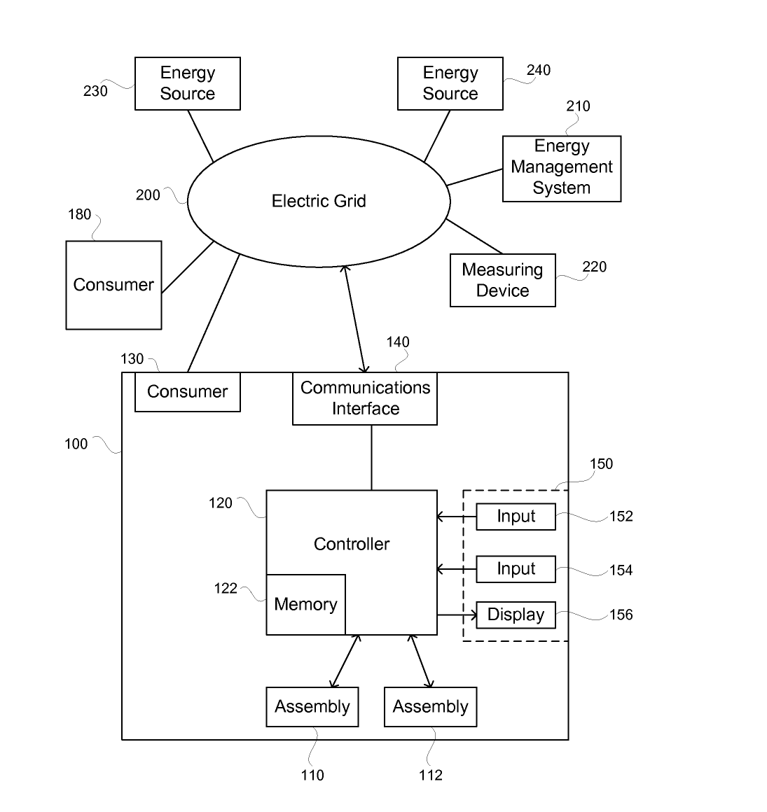

### CROSS-REFERENCE TO RELATED APPLICATION

This is a continuation application, under 35 U.S.C. §120, of copending international application No. PCT/EP2014/000414, filed Feb. 14, 2014, which designated the United States; this application also claims the priority, under 35 U.S.C. §119, of German patent application No. DE 10 2013 003 852.9, filed Mar. 6, 2013; the prior applications are herewith incorporated by reference in their entirety.

### BACKGROUND OF THE INVENTION

### Field of the Invention

The present invention relates to an electrical appliance, in particular an electronic domestic appliance, which can be integrated in an intelligent energy supply grid, and to a method for controlling the operation of such an electrical appliance.

Large electronic domestic appliances such as, for example, washing machines, tumble dryers, dishwashers, ovens or the like, generally use predefined program runs or sequences. There is, for example, a wash program for cotton at 60° C. and 900 rpm or a 90% drying program for synthetics, in each case with program sequence times of approximately 30 to 90 minutes, for example.

In addition, home automation systems (Smart Home, Smart House) are known in which a plurality of electrical loads or consumers (actuators, sensors, controllers, domestic appliances, etc.) are interlinked with one another. In such home automation systems, the consumers can be actuated centrally, the operation optimized, data interchanged, monitoring functions realized or the like. For this purpose, various, sometimes manufacturer-specific, systems and communications protocols are known.

Furthermore, intelligent energy supply or electricity grids (Smart Grid) are developed in which current-generating units, electrical stores, electrical consumers, grid operational equipment, measuring devices (Smart Meters) are interlinked with one another communicatively and in terms of control engineering. In such intelligent energy supply grids, in particular the electricity generation and the connected loads are intended to be controlled, monitored and if possible matched to one another. Such intelligent energy supply grids are gaining ever increasing importance in connection with renewable energies, the current generation performances of which can fluctuate significantly. The regulation of the energy currents in such a volatile energy supply grids can also be referred as Demand Control.

In this context, it is also known to couple the home automation system to an intelligent energy supply grid. Thus, for example, information on the available energy from the energy supply grid can be used in the home automation system to operate specific consumers in particular when a lot of energy and/or inexpensive energy is available. By virtue of simple switching-on and switching-off of the consumers depending on the energy resources available, a response to changes on relatively short time scales, such as are conventional in wind turbines and photovoltaic systems, is not possible in conventional systems, however.

### SUMMARY OF THE INVENTION

Therefore, the object of the invention consists in providing improved electrical appliances and improved operating methods for electrical appliances which are suitable for use in connection with intelligent energy supply grids.

The electrical appliance according to the invention has at least one assembly, an operating apparatus for the selection of a program run from at least one predefined program run by a user of the electrical appliance, a control apparatus for actuating the at least one assembly in accordance with the selected program run, and a communications interface, via which the control apparatus can communicate with an intelligent energy supply grid. The control apparatus is configured to modify the selected program run depending on energy supply information received from the intelligent energy supply grid via the communications interface during execution of the program run within predetermined limits and to actuate the at least one assembly in accordance with the modified program run.

The electrical appliance of the invention can communicate with the intelligent energy supply grid, in particular receive energy supply information, via the communications interface. Since the control device is capable of modifying a selected program run during execution thereof (at least within predetermined limits), the electrical appliance can respond flexibly also to short-term changes in the energy supply grid, in contrast to conventional systems. The advantages of an intelligent energy supply grid can be used more effectively for integration or linking of the electrical appliance according to the invention in/to the energy supply grid since load operation and available energy supply can be matched better to one another or synchronized better with one another. The energy saving possibilities are therefore even more diverse and greater than in conventional electrical appliances.

The invention can advantageously be used in particular for electronic domestic appliances, specifically large domestic appliances such as washing machines, tumble dryers, dishwashers, ovens, heat pumps or the like, without the invention being intended to be restricted to this type of electrical appliance.

The electrical appliance has at least one assembly. An “assembly” in this context is intended to be understood to mean a technical component of the electrical appliance which performs a specific, typically appliance-specific function. Assemblies in this sense include, depending on the type of respective electrical appliance, in particular but not exclusively heaters, fluid pumps, electric motors (for example for laundry drums), fans, coolers or the like.

The electrical appliance has an operating apparatus. The operating apparatus preferably has input and/or output apparatuses fitted on the electrical appliance (for example in the form of a control panel) and/or an interface for communicating with separate input and/or output apparatuses (for example remote control, control integrated in the intelligent energy supply grid, etc.).

The electrical appliance has at least one “predefined program run”, i.e. a preset time sequence of operating states of one or more assemblies. In this sense, the predefined program runs include, depending on the type of respective electrical appliance, in particular but not exclusively wash programs, dry programs, rinse programs, cooking programs, water heating programs, or the like. A program run preferably contains one or more operational parameters (for example temperature, speed, pressure, flow rate) for one or more successive time periods. The predefined program runs can in this context be completely preset with all operational parameters or individual operational parameters which are freely selectable or selectable from a selection can be included. For example, a washing machine as the electrical appliance contains completely preset program runs (for example color washing, hot wash, etc.) or program runs with individual selectable operational parameters (for example color wash with different wash temperatures and/or drying speeds, etc.).

In accordance with the invention, the control device can modify the program run selected by a user not only prior to or at the program start but also during the execution of the program run. Thus, the electrical appliance can respond more quickly and better in particular to volatile energy supply grids.

In order to ensure a desired or satisfactory result of the respective program run selected by the user, the program run can be modified only within predetermined limits. Preferably, the control apparatus is configured to modify at least one operational parameter of the selected program run within predetermined limits in order to respond flexibly to variable energy supply information from the intelligent energy supply grid. The modification within predetermined limits is in contrast to free, arbitrary changing of the program run or its operational parameters. Preferably, the modification of at least one operational parameter within predetermined limits includes alternate modification of at least two operational parameters. For example, in the case of a washing machine, a selected wash temperature should only be increased or decreased by at most approximately 5-10° C. with, at the same time, shortening or extension of the wash time in order to still achieve the desired cleaning effect of the wash program. Preferably, the limits of permissible modifications or parameterizations are defined via functional mapping, families of characteristics or the like.

The electrical appliance has a communications interface for communication with an intelligent energy supply grid. The communication takes place at least from the energy supply grid to the electrical appliance, but preferably in both directions. The communications interface is preferably matched to the energy supply grid, in particular to the communications protocol (for example KNX, Zigbee, etc.) used by the energy supply grid. The communications interface is preferably configured for wireless communication (for example radio) and/or wired communication (for example PLC, bus system, etc.). The communications interface is preferably integrated in the electrical appliance or is connected to the electrical appliance as a separate component. The communications interface is preferably replaceable and/or adaptable so that the electrical appliance can be matched variably to the respective energy supply grid or its communications protocol. Particularly preferably, the communications interface is in the form of a communications module which can support one or more communications protocols.

The “intelligent energy supply grid” preferably has at least one energy supply source and an energy management system (EMS) for supervising, monitoring and controlling the energy supply to at least one connected electrical consumer. The at least one energy supply source preferably has at least one external energy supply source (for example public electricity grid with or without renewable energy) and/or at least one local energy supply source (for example photovoltaic system, wind turbine, engine-based cogeneration plant, etc.). The EMS is preferably coupled (i.e. wireless or wired connection) to input and/or output devices such as, for example, operating units, smart phones, etc.

The “energy supply information” from the intelligent energy supply grid in this context refers to any type of information relating to the energy or energy flows available in the energy supply grid. The energy supply information includes in particular, but not exclusively, information on a sufficient or scarce energy quantity, the present energy consumption prices, the present loading on the energy supply grid by the connected consumers, expected future developments in this information, or the like.

In a preferred configuration of the invention, the operating apparatus is configured for the selection of an optimization criterion from at least one preset optimization criterion by a user of the electrical appliance, and the control apparatus is configured to modify the selected program run depending on the selected optimization criterion.

By virtue of the selection of an optimization criterion, the user can match the operation of the electrical appliance to his wishes and requirements. An “optimization criterion” is in this context intended to be understood to mean any target of possible optimization of the operation of the electrical appliance. The optimization criteria in this sense include in particular, but not exclusively, the energy costs, the energy quantity, the optimization per se (desired/not desired), the preference for local energy sources, the preference for renewable energies, or the like.

In a preferred configuration of the invention, the control apparatus is configured to communicate a modification to the selected program run to the intelligent energy supply grid via the communications interface. In this way, the energy supply grid receives corresponding feedback and can respond to this in a corresponding manner, if appropriate. Preferably, an energy management system of the intelligent energy supply grid can match the distribution of the available energy, can match the energy quantities made available by the connected energy supply sources, or the like.

The subject matter of the invention also consists in an intelligent energy supply grid containing at least one energy supply source, an energy management system and at least one above-described electrical appliance of the invention. One or more electrical appliances of the invention can be connected to the energy supply grid. Optionally, in addition one or more other electrical appliances can be connected as electrical consumers/loads to the energy supply grid.

The intelligent energy supply grid (Smart Grid) preferably has one or more intelligent electricity meters (Smart Meters) for detecting the current consumption and/or the current generation.

The method for controlling the operation of an electrical appliance containing at least one assembly has the following steps: selection of a program run from at least one predefined program run by a user of the electrical appliance; actuation of the at least one assembly in accordance with the selected program run; reception of energy supply information from an intelligent energy supply grid; modification, if appropriate, of the selected program run depending on the received energy supply information during the execution of the program run within predetermined limits; and actuation of the at least one assembly in accordance with the possibly modified program run.

It is possible to achieve the same advantages with this method according to the invention as have been described above in connection with the electrical appliance according to the invention. The advantages, definitions of terminology and preferred embodiments of this operating method of the invention correspond to those of the above-described electrical appliance of the invention.

In accordance with the invention, the program run selected by the user is modified, if appropriate, depending on the received energy supply information. That is to say that the selected program run is modified, corresponding to the received energy supply information, if this is necessary or desirable or is judged so by the control apparatus or is not modified if this is not required or desirable or is judged so by the control apparatus or if this is not possible.

In a preferred configuration of the invention, in order to modify the selected program run, at least one operational parameter of the selected program run is modified within predetermined limits.

In a preferred configuration of the invention, an optimization criterion is selected from at least one preset optimization criterion by a user, and the selected program run is modified depending on the selected optimization criterion. If only a preset optimization criterion exists, this can be selected by the user or not.

In a preferred configuration of the invention, a modification to the selected program run is communicated to the intelligent energy supply grid.

Other features which are considered as characteristic for the invention are set forth in the appended claims.

Although the invention is illustrated and described herein as embodied in an electrical appliance and a method for controlling the operation of an electrical appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing schematically shows the configuration of an intelligent energy supply grid having an electrical appliance according to the invention.

### DETAILED DESCRIPTION OF THE INVENTION

Referring now to the single FIGURE of the drawing in detail, there is shown an intelligent energy supply grid or electricity grid (Smart Grid) 200, which in this exemplary embodiment is combined with a home automation system. The energy supply grid has an energy management system (EMS) 210 and at least one intelligent measuring device (Smart Meter) 220.

The energy management system 210 is used for supervising, monitoring and controlling the energy supply to at least one connected electrical consumer 100, 180. In this case, it is coupled to input and/or output devices (not illustrated) such as operating units, smart phones, etc. The energy supply grid 200 and its components operate using a specific communications protocol (for example KNX, Zigbee, etc.) and are interlinked with one another wirelessly (for example by radio) or using wires (for example by PLC, bus system, etc.).

In this exemplary embodiment, the energy supply grid 200 is supplied power from at least one external energy supply source 240 (for example public electricity grid, with or without renewable energies) and at least one local energy supply source 230 (for example photovoltaic system, wind turbine, engine-based cogeneration plant, etc.). The intelligent measuring devices 220 are used, inter alia, for detecting the electricity consumption of the connected consumers 100, 180 and the electricity quantities fed in by the energy supply sources 230, 240.

The energy management system 210 receives these measured values from the intelligent measuring devices 220. In addition, the energy management system 210 receives various information on available electricity quantities, electricity prices and electricity origin (for example proportion of renewable energies) for the present time and possibly also for the future from the at least one external energy supply source 240. These measured values and information are included in the energy supply information within the meaning of the present invention.

At least one “intelligent” electrical appliance 100 in accordance with the present invention is connected to this energy supply grid 200. In addition, one or more further electrical appliances 180 which are not configured in accordance with the present invention can also be connected to the energy supply grid 200. The electrical appliances 100 and further electrical appliances 180 form electrical loads or consumers of the energy supply grid 200.

The electrical appliance 100 according to the invention is an electronic domestic appliance such as, for example, a washing machine, a tumble dryer, a dishwasher, an oven, a water heater or the like. The further electrical appliances 180 include, in addition to electronic domestic appliances without a control apparatus according to the invention as described below, other electronic appliances, actuators, sensors or the like as well, such as can also be integrated in conventional home automation systems.

The electrical appliance 100 (for example washing machine) in this exemplary embodiment has a first assembly 110 (for example heater), a second assembly 112 (for example electric motor of the washing drum) and possibly one or more further assemblies (not illustrated). The assemblies 110, 112 of the electrical appliance 100 are actuated and supervised by a control apparatus 120. The control apparatus 120 has, inter alia, a memory 122, in which the predefined program runs of the electrical appliance 100 are stored, a microcontroller (not illustrated) or the like.

As indicated in the figure, the electrical appliance 100 also has an electrical connection 130, which can be connected to the energy supply grid 200 for the power supply to the electrical appliance 100. For this purpose, an electrical cable can typically be used.

Furthermore, the electrical appliance 100 has a communications interface 140 for the communication between its control apparatus 120 and the energy supply grid 200. The communications interface 140 is configured for wireless and/or wired communication. Optionally, it can also be combined with the electrical connection 130 and use, for example, the electrical lines as communications link. In addition, the communications interface 140 can be integrated in the electrical appliance 100 or can be fitted as a separate component (for example as a module) on the electrical appliance 100.

The communications interface 140 is matched to the energy supply grid 200 or to the communications protocol used thereby. In other exemplary embodiments, the communications interface 140 is configured so as to be adaptable variably to the energy supply grid 200 or its communications protocol or is configured as a replaceable module unit.

The electrical appliance 100 furthermore has an operating apparatus 150, which is provided in the form of a control panel on the electrical appliance 100, for example. This operating apparatus 150 has a first input apparatus 152 for the selection of program runs, a second input apparatus 154 for the selection of optimization criteria and a display apparatus 156. The first and second input apparatuses 152, 154 can optionally also be in the form of a common input apparatus. In addition, the electrical appliance 100 is connected to further, remote input and/or output apparatuses (for example smartphone, etc.) via its communications interface 140 and the intelligent energy supply grid 200.

The control apparatus 120 of the electrical appliance is configured to control the assemblies 110, 112 in accordance with the program run selected via the first input apparatus 152. The selected program run in this case contains one or more predefined operational parameters for in each case one or more predefined time periods. Thus, for example, a predefined wash program for a hot wash which can be selected by the user from a plurality of predefined wash programs includes, for example, a wash temperature of 60° C. and a program duration of 60 minutes.

The control apparatus 120 of the electrical appliance 100 receives energy supply information via the communications interface 140 prior to and during the selected program run from the intelligent energy supply grid 200. For example, it is possible to communicate to the electrical appliance 100 that, at present, a large quantity of electricity is available from renewable energies of the local energy supply sources 230 which change electricity costs in the short term into a cheaper/more expensive electricity tariff (for example HT/LT) or the like.

The control apparatus 120 is configured to modify the selected program run prior to the program start, but in particular also during the execution of the program run, wherein this modification should only take place within predetermined limits, however. Then, the assemblies 110, 112 are actuated by the control apparatus 120 after the modified program run. The electrical appliance 100 or its control apparatus 120 can thus also respond flexibly to short-term changes in a volatile energy supply grid 200, with the result that load operation and available energy supply can be matched well to one another or synchronized well with one another. The result consists in particular in improved energy saving possibilities in comparison with conventional electrical appliances.

The modification of the selected program run by the control apparatus 120 includes changing one or more operational parameters (for example temperature, speed, time, etc.) of the program run, preferably mutual modification of at least two operational parameters. In order to maintain the predetermined limits, the permissible changes or parameterizations are defined, for example, via functional mapping or families of characteristics.

The outlined mode of operation of the electrical apparatus 100 will now be clarified using a specific example.

The wash result of a washing machine is critically dependent on the variables of the water temperature and the wash time. A user has selected, via the first input apparatus 152 of the operating apparatus 150, a wash program with 60° C. and 60 minutes, for example, from a plurality of predefined program runs. At the program start, a weighted ratio of supply and demand existed on the energy supply grid 200, for which reason the control apparatus 120 actuates the assemblies 110, 112 initially in accordance with the selected program run.

During the wash program, the electricity generation performance of the local energy generation source 230 is impaired, for example, owing to severe cloud coverage in the case of a photovoltaic system. The weather forecasts show that no short-term improvement in these impaired circumstances is to be expected. This is communicated to the control apparatus 120 of the wash machine 100 from the energy supply grid 200 via the communications interface 140.

The control apparatus 120 modifies the selected wash program then to a reduced temperature of 55° C. and an extended wash time of 70 minutes, for example, in order to perform the washing operation in a more energy-saving manner. These permitted intervention limits are stored in the memory 122 of the control apparatus 120.

A more significant change to the operational parameters, for example to 40° C. and 2 hours, is outside the predetermined limits since this would negatively impair the wash result.

The changes performed are communicated to the user of the washing machine 100 via, for example, the display apparatus 156 of the operating apparatus 150 on the washing machine 100 or via the user's smart phone, which is coupled to the energy management system 210 of the energy supply grid 200.

In the case of new energy supply information from the energy supply grid 200, the control apparatus 120 can naturally also perform such modifications to the program run several times.

In a preferred exemplary embodiment, the user can additionally select an optimization criterion via the second input apparatus 154 of the operating apparatus 150.

For example, the user can in principle switch on or off the above-described functionality of matching the program runs to the intelligent energy supply grid. As suboptions, the optimization criteria include, for example, optimization of the energy consumption costs, optimization of the energy consumption, optimization of the consideration of renewable energies, optimization of the consideration of the local energy generation sources 230, etc.

For further clarification of the invention, possible program runs, operational parameters and changes are specified by way of example below for various electrical appliances 100.

A washing machine: matching of the water temperature, the hold time and the rotation frequency and sequence in certain program stages; limitation of the diversity of programs depending on the selected optimization criteria prior to the program start.

A tumble dryer: similar to washing machine, air temperature instead of water temperature, additionally variable air speeds.

A dishwasher: similar to the washing machine, additionally spray pressure, without variable rotation.

An oven: matching of temperature and hold time.

A microwave oven: matching of microwave power and hold time.

A steamer: matching of temperature and time.

A water heater and heat pumps: matching of power and operating time.

A swimming pool pump: matching of volume flow as a function of time.

A garden watering pump: matching of the volume flow as a function of time.

The following is a summary list of reference numerals and the corresponding structure used in the above description of the invention:
100 Electrical appliance, electronic domestic appliance
110 First assembly
112 Second assembly
120 Control apparatus
122 Memory
130 Electrical connection
140 Communications interface
150 Operating apparatus
152 First input apparatus (program runs)
154 Second input apparatus (optimization criteria)
156 Display apparatus
180 Further electrical appliance
200 Intelligent energy supply grid (Smart Grid)
210 Energy management system (EMS)
220 Intelligent electricity meters (Smart Meters)
230 Local energy source(s)
240 External energy source(s), public electricity grid

1. An electrical appliance, comprising:
at least one assembly;
an operating apparatus for selecting a program sequence from at least one predefined program sequence by a user of the electrical appliance;
a control apparatus for actuating said at least one assembly in accordance with a selected program sequence;
a communications interface via which said control apparatus can communicate with an intelligent energy supply grid; and
the control apparatus being configured to modify the selected program sequence depending on energy supply information obtained from the intelligent energy supply grid via said communications interface during execution of the selected program sequence within predetermined limits and to actuate said at least one assembly in accordance with a modified program sequence.

2. The electrical appliance according to claim 1, wherein said control apparatus is configured to modify at least one operation parameter of the selected program sequence within the predetermined limits.

3. The electrical appliance according to claim 1, wherein:
said operating apparatus is configured for a selection of an optimization criterion from at least one preset optimization criterion by the user of the electrical appliance; and
said control apparatus is configured to modify the selected program sequence depending on a selected optimization criterion.

4. The electrical appliance according to claim 1, wherein said control apparatus is configured to communicate a modification to the selected program sequence to the intelligent energy supply grid via said communications interface.

5. An intelligent energy supply grid, comprising:
at least one energy supply source;
an energy management system: and
at least one electrical appliance, said at least one electrical appliance, containing:
at least one assembly;
an operating apparatus for selecting a program sequence from at least one predefined program sequence by a user of said electrical appliance;
a control apparatus for actuating said at least one assembly in accordance with a selected program sequence;
a communications interface via which said control apparatus can communicate with other components of the intelligent energy supply grid; and
said control apparatus being configured to modify the selected program sequence depending on energy supply information obtained from the intelligent energy supply grid via said communications interface during execution of the selected program sequence within predetermined limits and to actuate said at least one assembly in accordance with a modified program sequence.

6. A method for controlling an operation of an electrical appliance having at least one assembly, which comprises the steps of:
selecting a program sequence from at least one predefined program sequence by a user of the electrical appliance;
actuating the at least one assembly in accordance with a selected program sequence;
receiving energy supply information from an intelligent energy supply grid;
modifying the selected program sequence in dependence on received energy supply information during an execution of the selected program sequence within predetermined limits; and
actuating the at least one assembly in accordance with a modified program sequence.

7. The method according to claim 6, which further comprises modifying at least one operational parameter of the selected program sequence within the predetermined limits in order to modify the selected program sequence.

8. The method according to claim 6, which further comprises:
selecting an optimization criterion from at least one preset optimization criterion by the user; and
modifying the selected program sequence depending on the optimization criterion selected.

9. The method according to claim 6, which further comprises communicating a modification to the selected program sequence to the intelligent energy supply grid.

10. The method according to claim 6, wherein the electrical appliance is an electronic domestic appliance.
